(19) United States
(12) Patent Application Publication
(10) Pub. No.: US 2020/0177753 A1
(43) Pub. Date: Jun. 4, 2020

(54) IMAGE LOG MANAGEMENT APPARATUS, INSPECTION APPARATUS, IMAGE FORMING APPARATUS, IMAGE READING APPARATUS, IMAGE FORMING SYSTEM, CONTROL METHOD, AND COMPUTER PROGRAM

(71) Applicant: KONICA MINOLTA, INC., Tokyo (JP)

(72) Inventor: Hiroaki Kubo, Muko-shi (JP)

(73) Assignee: KONICA MINOLTA, INC., Tokyo (JP)

(21) Appl. No.: 16/680,943

(22) Filed: Nov. 12, 2019

(30) Foreign Application Priority Data
Nov. 30, 2018 (JP) 2018-225909

(51) Int. Cl. H04N 1/00; H04N 1/21

(52) U.S. Cl. CPC H04N 1/00832; H04N 2201/0087; H04N 1/2166

(57) ABSTRACT

An image log management apparatus manages image data indicating an execution result of an image processing job on an image processing apparatus, as an image log, and includes: a hardware processor that: performs detection of whether a predetermined reference image is included in the image data related to the image processing job; and restricts storage of an entire image or a partial image as an image log, out of images represented by the image data, in a case where the reference image is detected.

The entire disclosure of Japanese patent Application No. 2018-225909, filed on Nov. 30, 2018, is incorporated herein by reference in its entirety.

### BACKGROUND

### Technological Field

The present invention relates to a technology for managing a record (log) of execution results of jobs such as copying, scanning, and printing executed by an image processing apparatus.

### Description of the Related Art

Conventionally, an electrophotographic image forming apparatus such as a printer and a copier has an anticounterfeit function for banknotes or the like.

According to JP 2014-113775 A, an image forming apparatus first forms an image on a sheet, then reads the image formed on the sheet, and compares the read image with a prohibited image such as a preset banknote or the like, and determines whether to permit the output of the sheet on which the image is formed. The apparatus includes a lock mechanism that prevents the sheet from being retrieved from the image forming apparatus or a shredder function that cuts the sheet to be used in a case where the apparatus determines that output is not permitted. In this manner, the printed product on which a prohibited image is formed is prevented from being output to the outside of the image forming apparatus.

However, in a case where the image formed on the sheet is an image generated with the magnification changed from that of the prohibited image, the degree of similarity between the image read from the sheet and the preset prohibited image might be determined to be low, leading to counterfeiting of the banknotes or the like.

In order to handle such a problem, JP 2000-232578 A describes that an image processing apparatus has preliminarily registered a plurality of types of pattern data of images of special documents such as banknotes, and that, in a case where an input image is an enlarged or reduced image, reverse scaling processing is applied to restore the unmagnified image, and the unmagnified image is compared with the pattern data of each of registered special documents, and thereby discriminates whether this image is a special document image. In a case where the image is discriminated to be the special document image, anticounterfeit processing such as outputting an uncolored image is performed.

According to JP 2007-160674 A, after printing is executed by the image forming apparatus, a job log that is an execution record of the print job is accumulated in the image forming apparatus. A job log includes, for example, a job ID, job type, job reception time, job end time, job status, or the like. A job log is sometimes generated as an image log from an image handled in the job. Jobs can be managed by accumulating job logs generated in this manner.

As described above, each of JP 2014-113775 A and JP 2000-232578 A suppresses output of a printed product on which a prohibited image such as a banknote is formed from the image forming apparatus to the outside, or applies anticounterfeit processing such as outputting an uncolored image and thereby prevents a printed product on which a prohibited image is formed from being used as a genuine product.

Unfortunately, however, as illustrated in JP 2007-160674 A, in a case where an image log is generated from an image on a document and a prohibited image is included in the image log, the leakage of the image log to the outside of the image forming apparatus would lead to an unauthorized use of the prohibited image included in the image log.

### SUMMARY

In order to solve this problem, an object of the present invention is to provide an image log management apparatus, an inspection apparatus, an image forming apparatus, an image reading apparatus, an image forming system, a control method, and a computer program capable of prevent an unauthorized use of a prohibited image included in an image log.

To achieve the abovementioned object, according to an aspect of the present invention, there is provided an image log management apparatus that manages image data indicating an execution result of an image processing job on an image processing apparatus, as an image log, and the image log management apparatus reflecting one aspect of the present invention comprises: a hardware processor that: performs detection of whether a predetermined reference image is included in the image data related to the image processing job; and restricts storage of an entire image or a partial image as an image log, out of images represented by the image data, in a case where the reference image is detected.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates a configuration of an image log management system according to a first embodiment;

FIG. 2 is a view illustrating a schematic configuration of an image forming system;

FIG. 3 is a block diagram illustrating a configuration of a main controller and devices connected to the main controller;

FIG. 4 is a block diagram illustrating a flow of copy job execution and log information generation in the image forming system;

FIG. 5 is a block diagram illustrating a configuration of a server device;

FIG. 6 illustrates an example of print image data, a printed product, and a print image log;

FIG. 7 is a flowchart illustrating operation in an image log management system;

FIG. 8 illustrates an example of print image data, a printed product, and a print image log according to a first modification of a first embodiment;

FIG. 9 is a flowchart illustrating operation according to the first modification;

FIG. 10 illustrates an example of print image data, a printed product, and a print image log according to a second modification of the first embodiment;

FIG. 11 is a flowchart illustrating operation according to the second modification;

FIG. 12 illustrates an example of print image data, a printed product, and print image logs according to a third modification of the first embodiment;

FIG. 13 is a flowchart illustrating operation according to the third modification;

FIG. 14 is a diagram illustrating a schematic configuration of an image forming system in an image log management system 6e according to the second embodiment;

FIG. 15 is a block diagram illustrating a configuration of the main controller of the image forming system, devices connected to the main controller, and the configuration of a main controller;

FIG. 16 is a block diagram illustrating a flow of copy job execution and log information generation in the image forming system; and

FIG. 17 is a flowchart illustrating operation in the image log management system.

### DETAILED DESCRIPTION OF EMBODIMENTS

Hereinafter, one or more embodiments of the present invention will be described with reference to the drawings. However, the scope of the invention is not limited to the disclosed embodiments.

### 1 First Embodiment

An image log management system 6 according to an embodiment of the present invention will be described with reference to the drawings.

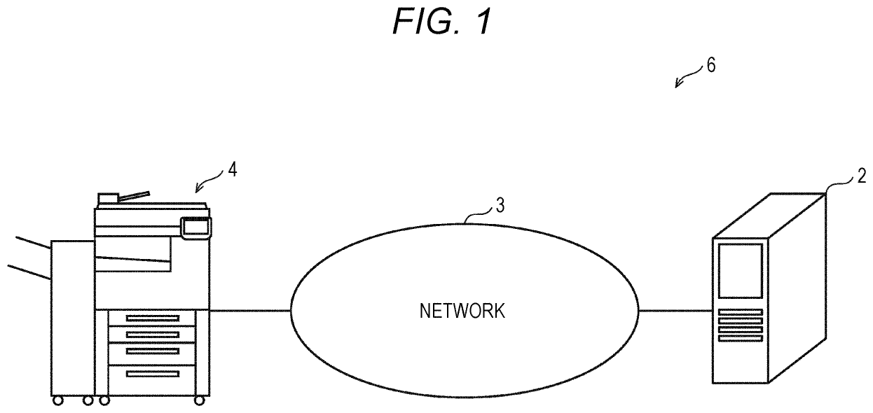

As illustrated in FIG. 1, the image log management system 6 includes an image forming system 4 and a server device 2. The image forming system 4 and the server device 2 are connected with each other via a communication network 3.

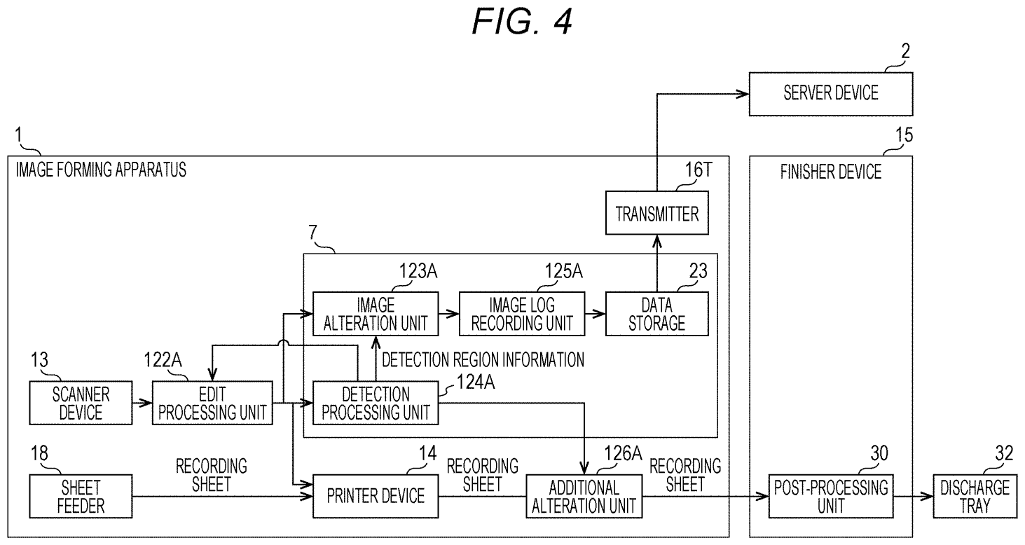

The image forming system 4 executes image processing jobs such as: a copy job (image reading and image forming job) of reading a document surface to generate image data, and forms an image represented by the generated image data on a recording sheet by electrophotography; a scan job (image reading job) of reading a document surface and generating image data; or a print job (reception and image forming job) of receiving image data from an external terminal device such as a personal computer (PC) and forming an image on a recording sheet by electrophotography. The image forming system 4 also includes an image log management apparatus 7 (FIG. 4) that manages image data indicating an execution result of each of jobs as an image log. The log information includes an image log generated from an image handled in each of jobs. The log information further includes information such as a job ID to identify a job, a job type, a job reception time, a job end time, and a job status. The image forming system 4 transmits generated log information to the server device 2 via the communication network 3. The server device 2 receives log information from the image forming system 4 and internally accumulates the received log information.

The log information accumulated in the server device 2 is used for managing a copy job, a scan job, a print job, or the like, executed in the image forming system 4.

1.1 Image Forming System 4

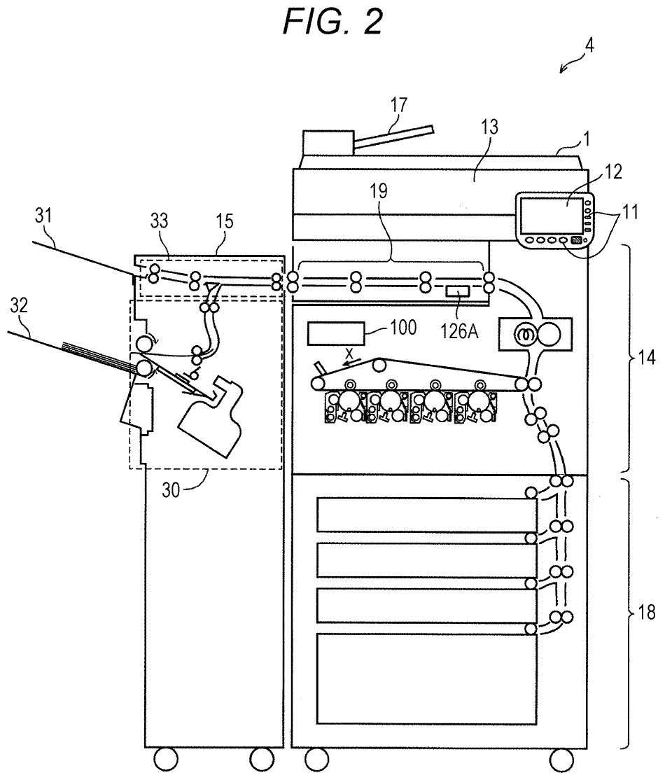

As illustrated in FIG. 2, the image forming system 4 includes: an image forming apparatus 1 (image processing apparatus) that forms an image on a recording sheet by electrophotography; and a finisher device 15 as an optional device that perform post-processing such as stapling on a bundle of recording sheets on which images are formed output from the image forming apparatus 1.

(1) Image Forming Apparatus 1

The image forming apparatus 1 is a tandem type color multifunction peripheral (M P) having functions of a scanner, a printer, a copier, a facsimile, a document server, or the like.

As illustrated in FIG. 2, the image forming apparatus 1 includes a sheet feeder 18 for storing and feeding recording sheets, at the bottom of housing. Above the sheet feeder 18, a printer device 14 for forming an image by electrophotography is provided. A conveyance unit 19 is provided further above the printer device 14. A display device 12 that displays an operation screen and an operation device 11 that receives user's input operation are provided above the conveyance unit 19. A scanner device 13 (image reader) that reads a document and generates image data is provided above the conveyance unit 19. A document feeder 17 is provided above the scanner device 13.

The document feeder 17 conveys the documents set on the document tray one by one to a document glass plate. The scanner device 13 uses a scanner movement and reads an image of a document conveyed to a predetermined position on a document glass plate by the document feeder 17, and obtains image data containing red (R), green (G), and blue (B) multi-value digital signals.

Image data of each of color components obtained by the scanner device 13 undergoes various types of data processing in a main controller 100 described below, so as to be further converted into image data of individual reproducible colors of yellow (Y), magenta (M), cyan (C), and black (K).

The printer device 14 includes an intermediate transfer belt, a driving roller that stretches the intermediate transfer belt, a driven roller, a backup roller, and an image forming part for each of reproducible colors arranged at predetermined intervals along a running direction X of the intermediate transfer belt so as to face the intermediate transfer belt, fixing unit, and the main controller 100.

Each of the image forming parts includes a photoconductive drum being an image carrier, an LED array for exposing and scanning the surface of the photoconductive drum, a charger, a developing device, a cleaner, and a primary transfer roller.

The sheet feeder 18 includes a plurality of sheet feeding cassettes that store recording sheets of different sizes, and a plurality of pickup rollers for feeding out the recording sheets from the sheet feeding cassettes to the conveyance path.

In each of the image forming parts, each of the photoconductive drums is uniformly charged by a charging charger and exposed by an LED array to form an electrostatic latent image on the surface of the photoconductive drum. Each of electrostatic latent images is developed by a developing device of each of colors, and a toner image of each of colors (Y to K colors) is formed on the surface of each of the photoconductive drums.

The toner image is sequentially transferred onto the front surface of the intermediate transfer belt by the electrostatic action of each of the primary transfer rollers disposed on the back surface side of the intermediate transfer belt.

Meanwhile, a recording sheet is fed from one of the sheet feeding cassettes of the sheet feeder 18 together with the image forming operation of each of the image forming parts. The recording sheet is conveyed on the conveyance path toward a position (secondary transfer position) at which the secondary transfer roller and the backup roller face each other with the intermediate transfer belt interposed therebetween. A toner image of Y to K colors on the intermediate transfer belt is transferred in the secondary transfer to the recording sheet by the electrostatic action of the secondary transfer roller at the secondary transfer position. The recording sheet on which the Y to K color toner images are transferred in the secondary transfer is further conveyed to the fixing unit.

The toner image on the surface of the recording sheet is melted and fixed onto the surface of the recording sheet by heating and pressure when passing through a fixing nip formed between a heating roller of the fixing unit and the pressure roller pressed against the fixing roller. The recording sheet passes through the fixing unit and is sent to the conveyance unit 19.

The conveyance unit 19 includes a conveyance path provided in the horizontal direction. Furthermore, an additional alteration unit 126A is provided along the conveyance path. In a case where a prohibited image or a prohibited mark described below is detected, the additional alteration unit 126A put a detection confirmation mark indicating detection of a prohibited image or a prohibited mark, on the surface of the recording sheet conveyed along the conveyance path. The recording sheet carrying a formed image is output to the finisher device 15 by a plurality of conveyance roller pairs arranged along the conveyance path.

The display device 12 includes a display unit and a touch panel unit formed by a liquid crystal display panel or the like. The display unit displays screens such as a screen that displays a message or gives an instruction to the user, a screen for inputting the user's setting content and processing content, or a screen indicating an image formed by the image forming apparatus 1 and its processing result. The touch panel unit detects a position touched by the user with a finger and transmits a signal indicating the detected position to the main controller 100.

The operation device 11 includes a plurality of keys for inputting numbers, texts, symbols, etc., a sensor that recognizes the pressed key, and a transmission circuit for transmitting a signal indicating the recognized key to the main controller 100. The operation device 11 receives user's instruction to start copying, setting of the number of copies, setting of duplication conditions, setting of post-processing such as stapling in the finisher device 15 as an optional device (staple ON/OFF setting), or the like, and notifies the main controller 100 of the received content.

In this manner, each of the operation device 11 and the display device 12 serves as a user interface enabling the user to directly operate the image forming apparatus 1. Note that an application program and a driver program for giving a command to the image forming apparatus 1 may be installed in the PC connected to the communication network 3. Therefore, the user can also remotely operate the image forming apparatus 1 using a PC.

The image forming apparatus 1 can be set to be disabled unless authentication based on registered user information is performed.

(2) Finisher device 15

The finisher device 15 includes, as post-processing, an alignment processing function of aligning a bundle of a plurality of recording sheets (sheet bundle) and a staple processing function of stapling the sheet bundle, and executes each of the processing functions in response to an instruction from the image forming apparatus 1.

As illustrated in FIG. 2, the finisher device 15 includes, inside the housing, a post-processing unit 30, and a conveyance path 33 provided above the post-processing unit 30 so as to face the conveyance unit 19.

In a case where the finisher device 15 is not to execute post-processing such as sheet bundle alignment or stapling on the recording sheet output from the conveyance unit 19, the finisher device 15 conveys the recording sheet through the conveyance path 33 and discharges the sheet to a discharge tray 31.

In contrast, in a case where the finisher device 15 is to execute post-processing, the recording sheet output from the conveyance unit 19 is branched in the conveyance path 33 and conveyed to the post-processing unit 30. The post-processing unit 30 aligns the sheet bundle, staples the sheet bundle, and discharges the aligned and stapled sheet bundle to a discharge tray 32.

The finisher device 15 may have a post-processing function of performing punching (two-hole punching) at the left end of the sheet bundle.

1.2 Main Controller 100

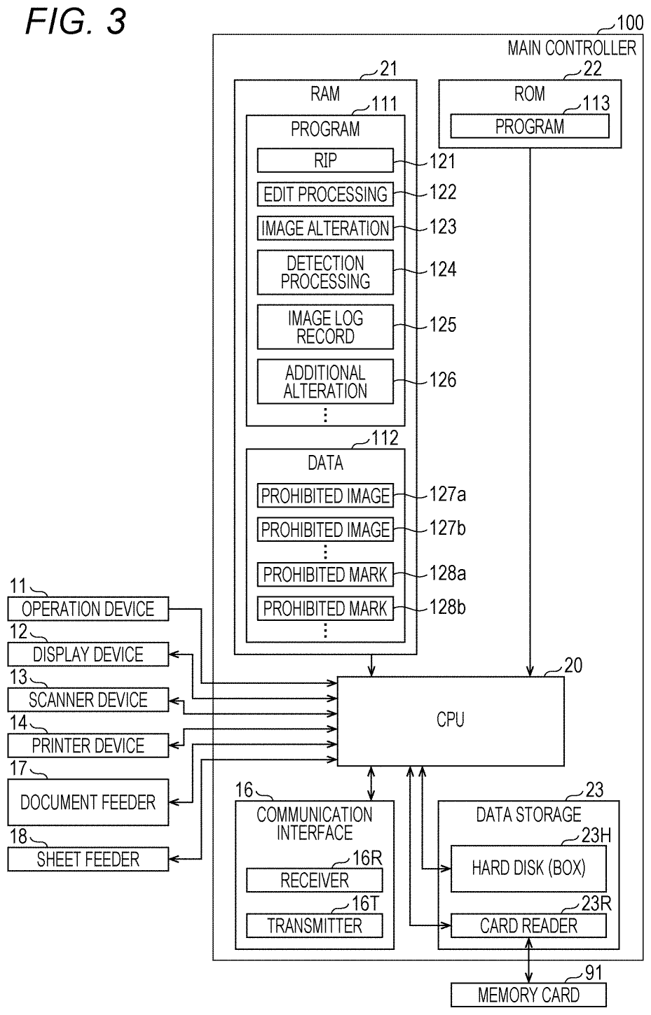

As illustrated in FIG. 3, the main controller 100 includes a CPU 20, RAM 21, ROM 22, a communication interface 16, and data storage 23.

A program 113 is stored in the ROM 22. The program 113 is, for example, a control computer program for controlling the operation device 11, the display device 12, the scanner device 13, the printer device 14, the communication interface 16, the document feeder 17, the sheet feeder 18, and the data storage 23.

The RAM 21 stores a program 111 and data 112. The data 112 includes various control variables, the number of copies set by the operation panel, and prohibited images 127a, 127b, . . . , and prohibited marks 128a, 128b, . . . . The RAM 21 provides a work area to be used in execution of programs by the CPU 20. The prohibited images 127a, 127b, . . . , the prohibited marks 128a, 128b, . . . , and the program 111 will be described below.

The CPU 20 operates in accordance with the program 113 stored in the ROM 22 to control devices such as the operation device 11, the display device 12, the scanner device 13, the printer device 14, the communication interface 16, the document feeder 17, the sheet feeder 18, and the data storage 23.

The communication interface 16 includes a receiver 16R and a transmitter 16T. The receiver 16R receives a print job from an external terminal device such as a PC via a communication network 3 such as a local area network (LAN), for example. The transmitter 16T transmits, for example, image data read from the document surface by the scanner device 13 to an external terminal device via the communication network 3. The communication interface 16 may include a wireless communication device in order to transmit/receive data to/from a mobile terminal In addition, the communication interface 16 may include a Network Interface Card (NIC), a modem, a terminal adapter (TA), or the like.

The data storage 23 includes a hard disk 23H and a card reader 23R. The hard disk 23H is used for storing image data and other data. The card reader 23R reads data stored in a memory card 91 or writes data to the memory card 91.

1.3 Program 111 and Data 112 Stored in RAM 21

The program 111 stored in the RAM 21 includes a RIP program 121, an edit processing program 122, an image alteration program 123, a detection processing program 124, an image log recording program 125, and an additional alteration program 126, as illustrated in FIG. 3.

Furthermore, as illustrated in FIG. 3, the data 112 includes prohibited images 127a, 127b, . . . and prohibited marks 128a, 128b, . . . as reference images indicating prohibition of duplication. Here, the reference image may include a prohibited image for which duplication is prohibited or a prohibited image indicating prohibition of duplication. The reference image may include a feature pattern having a predetermined feature.

Here, the CPU 20 operates in accordance with the edit processing program 122, the image alteration program 123, the detection processing program 124, and the image log recording program 125, so as to enable operation of an edit processing unit 122A, an image alteration unit 123A (storage restriction unit), a detection processing unit 124A (detection unit), and an image log recording unit 125A, respectively, as illustrated in FIG. 4.

The image alteration unit 123A, the detection processing unit 124A, an image log recording unit 125A, and the data storage 23 forms the image log management apparatus 7 that manages image data indicating execution results of image processing jobs such as copy jobs, scan jobs, and print jobs, as image logs.

(1) Prohibited Images 127a, 127b, . . .

Each of prohibited images 127a, 127b, . . . (FIG. 3) is an entire image or a partial image of an image displayed on a duplication prohibited voucher surface, such as banknotes (Japanese banknotes and foreign banknotes), securities, cash vouchers, certificates, certifications, or licenses.

Here, one prohibited image may include, for example, the entire image illustrated on the surface of a thousand yen bill being a Japanese bank note, and another prohibited image may include the entire image illustrated on the back surface of the thousand yen bill. Furthermore, one prohibited image may be an image of a characteristic portion of the entire image illustrated on the front surface (or the back surface) of the thousand yen bill. Another prohibited image may be an image of another characteristic portion out of the entire image illustrated on the front surface (or the back surface) of the thousand yen bill. The similar applies to other vouchers other than banknotes.

(2) Prohibited Marks 128a, 128b, . . .

In a case where the text mark on the surface of the document is a prohibited mark indicating that it is a trade secret, for example, “Confidential Information”, “Undisclosed Information”, “Confidential”, or “For internal use only”, etc., the content described in the document need to be protected so as not to leak outside as trade secrets. Here, the trade secret includes a technical secret that is technical information.

In this manner, the prohibited marks 128a, 128b, . . . (FIG. 3) are marks indicating that duplication of documents including trade secrets is prohibited.

(3) RIP Program 121

For example, the RIP program 121 generates image data from a print job received from an external terminal device via the communication network 3.

(4) Edit Processing Program 122

The edit processing program 122 performs color conversion on image data output from a RIP program 121 or the scanner device 13, formed of multi-value digital signals of red (R), green (G), and blue (B), for example, and thereby generates image data of individual reproducible colors of yellow (Y), magenta (M), cyan (C), and black (K) (color conversion). In addition, the edit processing program 122 generates reduced or enlarged image data by reducing or enlarging (performing magnification conversion on) the image data for a plurality of images one by one, for example. Furthermore, the edit processing program 122 generates, for example, 2-in-1 format image data by linking two pieces of reduced image data.

The edit processing program 122 outputs the image data after undergoing the above editing (color conversion, magnification conversion, etc.) to the image alteration program 123 and the detection processing program 124.

The edit processing program 122 receives a notification from the detection processing program 124 that a prohibited image or a prohibited mark has been detected. In a case where a notification that a prohibited image or a prohibited mark has been detected is received, detection region information described below is also received. After receiving the notification that the prohibited image or the prohibited mark has been detected, the edit processing program 122 overwrites, in the image data after undergoing the above editing (color conversion, magnification conversion, etc.) a high-density image including a plurality of pixels of a single color being densely arranged, over the region indicated by the received detection region information (that is, an image corresponding to a prohibited image or an image including a prohibited mark). Here, the size of the high-density image is the same size as the region indicated by the detection region information. The high-density image may be a solid image whose entire surface is covered with white (or other color) pixels. This would make it impossible for a person to recognize an image corresponding to the prohibited image or an image including the prohibited mark. As a high-density image to be used for overwriting may be an image including densely arranged hatching patterns or an image including densely arranged dot patterns instead of a solid image. The edit processing program 122 outputs image data in which the region indicated by the detection region information has been overwritten with a high-density image, to the printer device 14.

In a case where the edit processing program 122 has not received notification from the detection processing program 124 that the prohibited image and the prohibited mark have been detected, the edit processing program 122 outputs the image data after undergoing the above editing (color conversion, magnification conversion, etc.) to the printer device 14.

(5) Image Alteration Program 123

The image alteration program 123 performs image reduction (alteration) processing at a predetermined reduction rate (first reduction rate) on the image represented by the image data output from the edit processing program 122, generates a reduced image, and then, generates image data representing the reduced image, as log information. The image data representing the reduced image is used as log information (image log) indicating the execution result of a copy job or a scan job.

Note that the image alteration program 123 may generate an entire image represented by the image data, for the image represented by the image data output from the edit processing program 122, as log information (image log) without performing image reduction processing. Alternatively, a partial image of the image represented by the image data may be generated as log information (image log). The image alteration program 123 may perform pixel thinning processing instead of image reduction processing. The image alteration program 123 may perform enlargement/reduction conversion with various aspect ratios on the image representing the image data instead of the image reduction processing. The image alteration program 123 may perform color conversion of converting multi-value image data (color image data) into binary image data (monochrome image data) instead of the image reduction processing. The image alteration program 123 may use a combination of image reduction processing (or thinning processing), enlargement/reduction conversion and color conversion having various aspect ratios.

For the image represented by the image data output from the edit processing program 122, the image alteration program 123 may separate the image into a region including a graphic image representing a figure and a region including text image representing texts.

The image alteration program 123 may perform text recognition processing on the text image displayed in a text region, generate a text code indicating the text represented by each of text images, and may generate text data including text codes.

The image alteration program 123 receives from the detection processing program 124 a notification that a prohibited image has been detected or a notification that a prohibited mark has been detected, and detection region information. After receiving the notification that the prohibited image has been detected, the notification that the prohibited mark has been detected, and the detection region information, the image alteration program 123 discards (deletes) the entire generated log information. In this manner, since the generated log information is discarded, there will be no log information leakage to the outside.

In a case where log information is generated by reducing the image represented by the image data by the image alteration program 123, the region indicated by the detection region information is a corresponding region in the reduced image obtained by reducing the image data.

In a case where there is no reception of notification that the prohibited image is detected, the notification that the prohibited mark is detected, or the detection region information, the image alteration program 123 outputs the log information with no change to the image log recording program 125.

In a case where there is notification that a prohibited image has been detected or a notification that a prohibited mark has been detected, the log information is discarded, and therefore, the image alteration program 123 would not output the log information to the image log recording program 125.

(6) Detection Processing Program 124

The detection processing program 124 acquires image data after editing (color conversion, magnification conversion, or the like) from the edit processing program 122. Next, the detection processing program 124 detects whether the acquired image data includes a prohibited image or a prohibited mark as a reference image. In a case where a prohibited image is detected, the detection processing program 124 generates detection region information indicating a region (partial image) of the prohibited image in the image data. In a case where a prohibited image is detected, detection region information indicating an entire region of the image data (entire image) may be generated as the region where duplication is prohibited. In a case where a prohibited mark is detected, detection region information indicating an entire region of the image data is generated as the region where duplication is prohibited.

In a case where a prohibited image or a prohibited mark has been detected, the detection processing program 124 notifies the edit processing program 122, the image alteration program 123, and the additional alteration program 126 that the prohibited image or the prohibited mark has been detected. Furthermore, in a case where a prohibited image or a prohibited mark has been detected, the detection processing program 124 notifies the edit processing program 122 and the image alteration program 123 of the detection region information.

(7) Image Log Recording Program 125

The image log recording program 125 receives log information from the image alteration program 123. After receiving the log information, the image log recording program 125 writes the received log information onto the hard disk 23H of the data storage 23.

(8) Additional Alteration Program 126

The additional alteration program 126 receives a notification from the detection processing program 124 that a prohibited image has been detected or a prohibited mark has been detected. After receiving the notification that the prohibited image has been detected or that the prohibited mark has been detected, the additional alteration program 126 controls the additional alteration unit 126A to put, on the surface of the recording sheet, a detection confirmation mark indicating that the prohibited image or the prohibited mark has been detected.

1.4 Copy Job Execution and Log Information Generation in Image Forming System 4

As an example, execution of a copy job and generation of log information in the image forming system 4 will be described with reference to the block diagram illustrated in FIG. 4.

The sheet feeder 18 feeds a recording sheet to the printer device 14.

The scanner device 13 reads the document surface, generates image data, and outputs the generated image data to the edit processing unit 122A.

The edit processing unit 122A performs editing such as color conversion on the generated image data, and outputs the edited image data to the detection processing unit 124A and the image alteration unit 123A.

The detection processing unit 124A acquires the image data after being edited from the edit processing unit 122A. Next, the detection processing unit 124A detects a prohibited image or a prohibited mark from the acquired image data. After detecting the prohibited image or the prohibited mark, the detection processing unit 124A outputs the detection region information to the edit processing unit 122A and the image alteration unit 123A.

In a case where a prohibited image or a prohibited mark is detected, the edit processing unit 122A overwrites a high-density image over the region indicated by the detection region information, and outputs the image data over which the region indicated by the detection region information has been overwritten, to the printer device 14. In a case where a prohibited image and prohibited mark have not been detected, the edit processing unit 122A outputs image data (image data on which overwriting with the high-density image has not been performed) that has undergone editing such as color conversion, to the printer device 14.

The printer device 14 forms an image on a recording sheet. In a case where the prohibited image or the prohibited mark has been detected, the additional alteration unit 126A puts a detection confirmation mark indicating that the prohibited image or the prohibited mark has been detected, on the surface of the recording sheet. Next, the recording sheet is conveyed to the post-processing unit 30. The post-processing unit 30 staples the sheet bundle and discharges the aligned and stapled sheet bundle to the discharge tray 32.

The image alteration unit 123A (log generation unit) performs image reduction processing on the image data received from the edit processing unit 122A, and generates image data including the reduced image, as log information. In a case where a prohibited image has been detected, or in a case where a prohibited mark has been detected, the image alteration unit 123A discards the generated log information. In this manner, the generated log information is discarded in a case where a prohibited image is detected or in a case where a prohibited mark is detected, and thus, there would be no leakage of log information to the outside.

In a case where the prohibited image has not been detected and in a case where the prohibited mark has not been detected, the image alteration unit 123A outputs the log information with no change to the image log recording unit 125A.

The image log recording unit 125A writes the received log information in the data storage 23.

The transmitter 16T of the communication interface 16 periodically transmits the log information written in the data storage 23 to the server device 2 via the communication network 3.

Note that image data generated by the scanner device 13 and that has undergone editing such as color conversion by the edit processing unit 122A is also referred to as print image data. Furthermore, as described above, the log information is reduced image data generated by performing image reduction processing on the image data received from the edit processing unit 122A, and thus, sometimes is referred to as a print image log.

In the above, the detection processing unit 124A has detected a prohibited image or a prohibited mark for the image data generated by the scanner device 13. Of course, the present invention is not limited to this. The RIP program 121 generates image data from a print job received from an external terminal device via the communication network 3. The detection processing unit 124A may detect a prohibited image or a prohibited mark for the image data generated by the RIP program 121.

1.5 Server Device 2

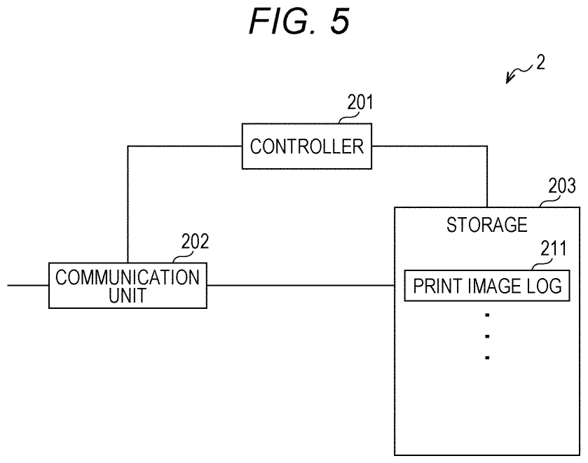

As illustrated in FIG. 5, the server device 2 includes a controller 201, a communication unit 202, and storage 203. The server device 2 is a computer system that includes a processor, a memory, or the like. The controller 201 and the communication unit 202 implement their functions when the processor operates in accordance with a computer program stored in the memory.

As an example, the storage 203 is formed with a hard disk, and includes a region for storing the print image log 211, . . . .

The communication unit 202 is connected to the communication network 3 and relays transmission/reception of information between an external device connected to the communication network 3, such as the image forming system 4, for example, and the controller 201.

The controller 201 controls the communication unit 202 and the storage 203.

Furthermore, the controller 201 receives a print image log from the image forming system 4 via the communication network 3 and the communication unit 202, and writes the received print image log in the storage 203.

Furthermore, the controller 201 analyzes the operating status in the image forming system 4 by using a print image log written in the storage 203, for example.

1.6 Print Image Data 131, Printed Product 132a, and Print Image Log 133a

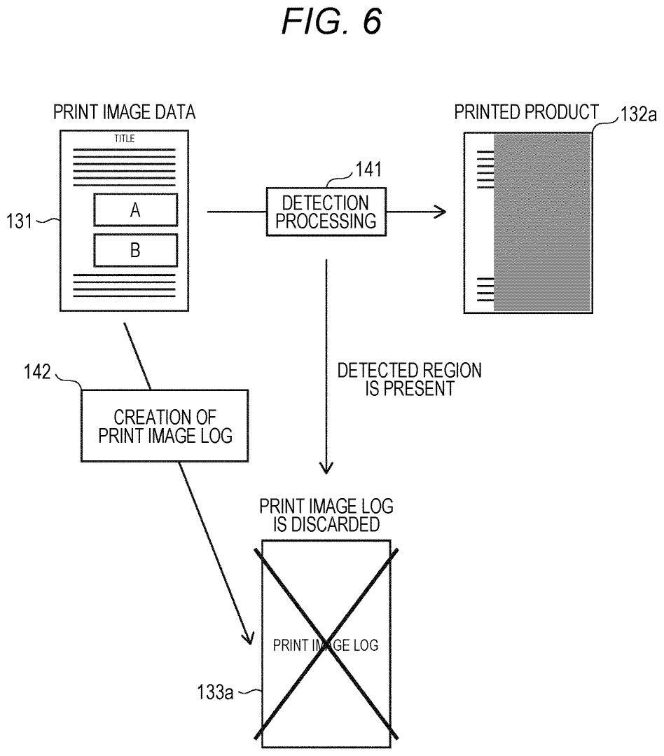

As an example, execution of a copy job and generation of log information in the image forming system 4 will be described using print image data 131, a printed product 132a, and a print image log 133a illustrated in FIG. 6.

For the print image data 131 generated by the scanner device 13 and edited by the edit processing unit 122A, the detection processing unit 124A performs detection processing 141 for a prohibited image or a prohibited mark. In a case where a prohibited image or a prohibited mark has been detected, the high-density image is overwritten over the prohibited image or the like of the print image data 131 by the edit processing unit 122A, and as a result, the printer device 14 outputs the printed product 132a. Note that the printed product 132a illustrated in FIG. 6 is an example of overwriting with a solid image.

Meanwhile, the image alteration unit 123A performs an image reduction processing on the print image data 131, so as to generate a print image log 133a including a reduced image, as log information. Here, in a case where a prohibited image or a prohibited mark has been detected by the detection processing unit 124A and there is a region indicated by the detection region information, the print image log 133a as log information is discarded by the image alteration unit 123A.

That is, in a case where a prohibited image or a prohibited mark is detected, the image alteration unit 123A restricts inclusion of the entire image out of the images represented by the image data with no change, in the log information generated as a result of executing the copy job.

In this manner, in a case where a prohibited image has been detected or in a case where a prohibited mark has been detected, the generated print image log 133a as log information is discarded, and thus, there would be no leakage of the log information to the outside.

1.7 Operation in Image Log Management System 6

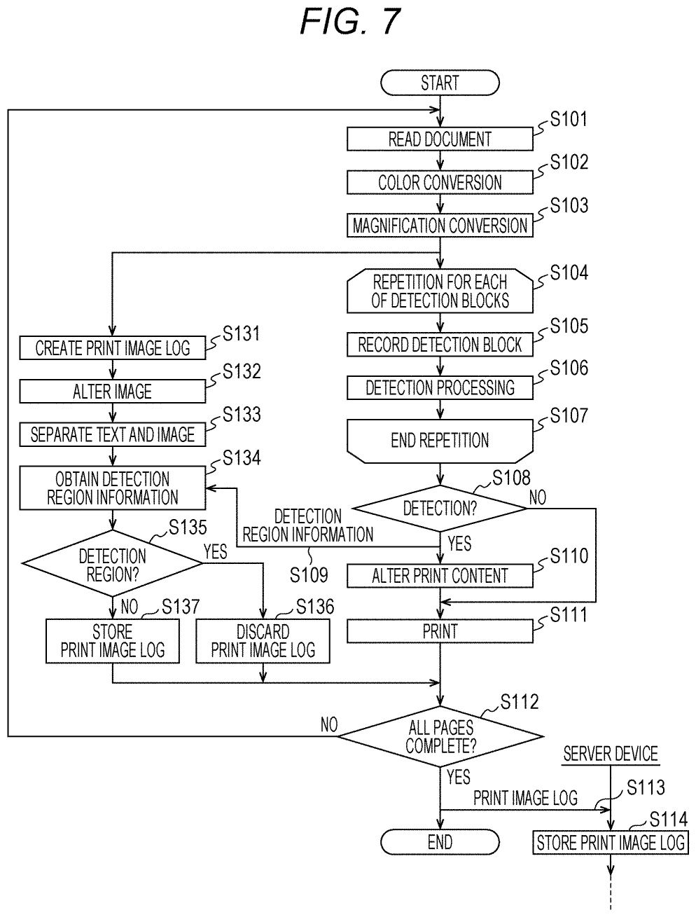

Operation in the image log management system 6 will be described with reference to the flowchart illustrated in FIG. 7.

The scanner device 13 reads an image from a document to generate image data (step S101). The edit processing unit 122A performs color conversion (step S102), and further performs magnification conversion (step S103).

The detection processing unit 124A repeats recording of a detection block to a buffer (RAM 21) (step S105) and detection processing (step S106) for the recorded detection block for each of a plurality of detection blocks, regarding the detection blocks forming the image data edited by the edit processing unit 122A (steps S104 to S107).

Next, in a case where a prohibited image or a prohibited mark is detected by the detection processing unit 124A (“Yes” in step S108), the edit processing unit 122A overwrites a high-density image over the region indicated by the detection region information in the image data (step S110). In this case, detection region information is notified from the detection processing unit 124A to the image alteration unit 123A (step S109).

In a case where a prohibited image or a prohibited mark has not been detected by the detection processing unit 124A (“none” in step S108), the overwriting in step 5110 and the notification in step S109 are not to be performed.

Next, the printer device 14 prints image data on which overwriting with the high-density image has been or has not been performed (step S111).

When printing of all pages is not completed for the copy job (NO in step S112), the processing returns to step S101 to repeat the processing.

When printing of all pages is completed for the copy job (YES in step S112), a print image log as log information is transmitted to the server device 2 by the transmitter 16T. The communication unit 202 of the server device 2 receives the print image log (step S113). The storage 203 stores the received print image log (step S114). This completes the processing for the print image log as log information.

Meanwhile, when the magnification conversion by the edit processing unit 122A is completed (step S103), the image alteration unit 123A reduces the image data and generates a print image log as log information (step S131). The image alteration unit 123A adds, to the print image log, a job ID for identifying a copy job, job type, job reception time (year/month/day, hour/minute/second), job end time (year/month/day, hour/minute/second), the job status, or the like (step S132). Next, the image alteration unit 123A (image alteration unit) separates a text data portion (text image representing texts) and an image data portion (graphic image representing figures) from the print image log (step S133).

Next, the image alteration unit 123A obtains detection region information (steps S109 and S134). In a case where no detection region exists (“none” in step S135), the image log recording unit 125A writes the print image log in the data storage 23 (step S137).

In contrast, in a case where the detection region exists (“Yes” in step S135), the image alteration unit 123A discards the print image log. The print image log is not to be written in the data storage 23 (step S136). For this reason, the print image log is not to be transmitted to the server device 2 in step S113.

Next, the control shifts to step S112, and the same processing is repeated.

1.8 Summary

As described above, the print image log as log information is discarded in a case where a prohibited image or a prohibited mark is detected in the image data as print image data. That is, in a case where a prohibited image or a prohibited mark is detected in the image data, there is a restriction on inclusion of the entire image out of the images represented by the image data in the log information with no change Therefore, there would be no leakage of the print image log as log information to the outside. In this manner, it is possible to prevent the leakage of the prohibited image or the image including the prohibited mark to the outside.

Note that the image alteration unit 123A (log generation unit) may generate log information including an entire image, a partial image, or an altered image obtained by altering these images among images represented by image data. Here, in a case where the reference image is detected, the image alteration unit 123A (storage restriction unit) may discard the generated log information.

### 2 First Modification

A first modification of the first embodiment will be described with a focus on differences from the first embodiment.

In the first embodiment, the print image log as log information is discarded in a case where a prohibited image or a prohibited mark has been detected. However, the present invention is not limited to this.

In the first modification, the image alteration unit 123A (storage restriction unit) erases the image of the region indicated by the detection region information in the generated log information in a case where a prohibited image or a prohibited mark has been detected. Specifically, a solid image that is a white image having the same size as the region is used to overwrite (mask) the region indicated by the detection region information, as a high-density image including a plurality of densely arranged pixels of a single color (overwriting of high-density image is performed over the region indicated by the detection region information). That is, the solid image is drawn to cover the region indicated by the detection region information. This makes it impossible for a person to recognize an image originally present in the region indicated by the detection region information.

Here, the solid image is not limited to a white image. The solid image may be an image of another color. Instead of overwriting with a solid image, an image formed with densely arranged hatching patterns may be overwritten over the region indicated by the detection region information, or an image formed with densely arranged dot patterns may be overwritten over the region indicated by the detection region information. These also make it impossible for a person to recognize an image originally present in the region indicated by the detection region information.

Here it is assumed a case where the document image data is used with no change as log information without reducing the image represented by the image data. In this case, when the detection region information indicates an entire image or a partial image of the image represented by the image data, and in a case where a prohibited image or a prohibited mark has been detected, the image alteration unit 123A restricts the inclusion of the entire image or a partial image out of the images represented by the image data, in the log information.

In contrast, it is assumed a case where a reduced image generated by reducing the image represented by the image data is used as the log information. In this case, when the detection region information indicates an entire image or a partial image of the image represented by the image data, and in a case where a prohibited image or a prohibited mark has been detected, the image alteration unit 123A may restrict the inclusion of an altered image obtained by altering (reducing) the entire image or a partial image out of the images represented by image data, in the log information.

(Print Image Data 131, Printed Product 132b, and Print Image Log 133b)

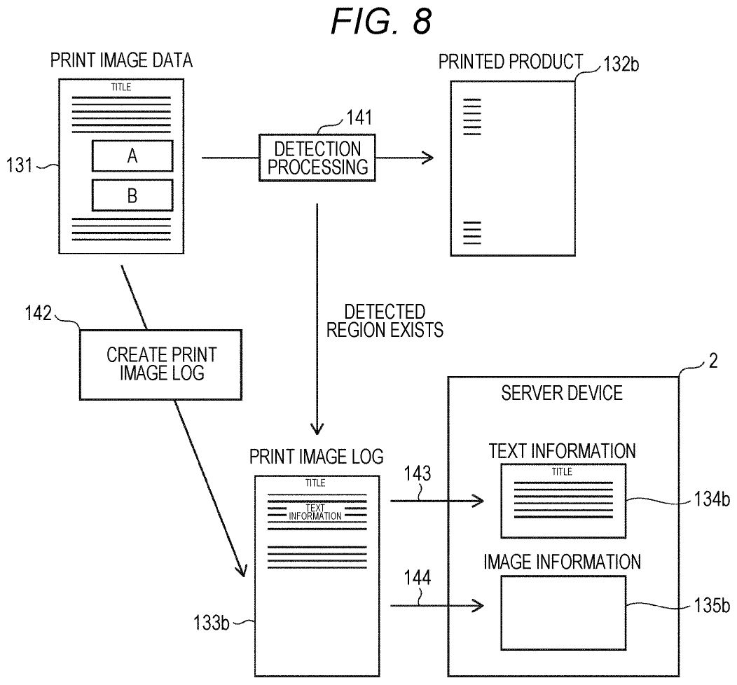

As an example, execution of a copy job and generation of log information in the first modification will be described using print image data 131, a printed product 132b, and a print image log 133b illustrated in FIG. 8. Here, the description will focus on differences from FIG. 6.

In a case where a prohibited image or a prohibited mark has been detected by the detection processing unit 124A, the image in the region indicated by the detection region information of the print image data 131 is erased by the edit processing unit 122A, and as a result, the printed product 132b is output by the printer device 14.

Meanwhile, the image alteration unit 123A generates the print image log 133b in which an image is reduced, as log information. Here, in a case where a prohibited image or a prohibited mark is detected by the detection processing unit 124A, the image alteration unit 123A erases the image of the region indicated by the detection region information in the print image log 133b as log information.

That is, in a case where a prohibited image is detected, the image alteration unit 123A restricts inclusion of an image corresponding to the prohibited image in the log information generated as a result of executing a copy job. In addition, in a case where a prohibited mark is detected, the image alteration unit 123A restricts inclusion of an image corresponding to the image represented by the acquired image data, in the generated log information.

The print image log 133b is separated into a text data portion and an image data portion by the image alteration unit 123A. Text information 134b is transmitted to the server device 2 as log information (143), and image information 135b is transmitted to the server device 2 (144). Here, the image information 135b includes a white image alone.

(Operation in Image Log Management System 6 of First Modification)

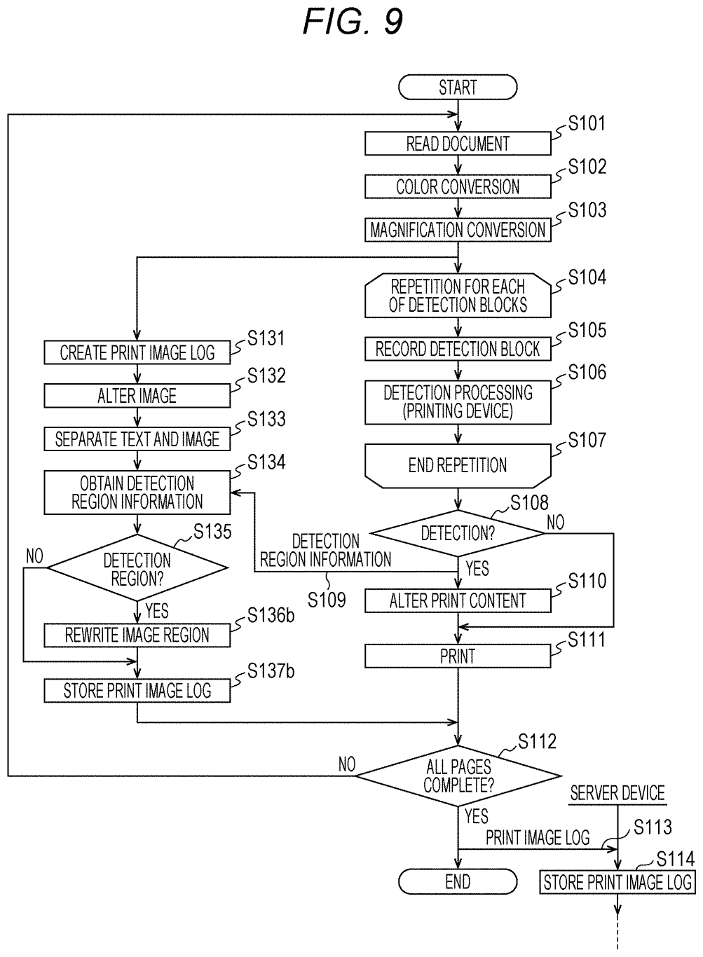

The operation of the image log management system 6 according to the first modification will be described with reference to the flowchart illustrated in FIG. 9. Here, the description will focus on the differences from the operation of the image log management system 6 of the first embodiment illustrated in FIG. 7.

In the first modification, the detection region information is obtained (steps S109 and S134). In a case where the detection region exists (“Yes” in step S135), the image alteration unit 123A performs rewriting to erase an image in the region indicated by the detection region information out of the print image log (step S136b).

Next, the image log recording unit 125A writes the print image log in the data storage 23 (step S137b).

(Summary)

In this manner, in a case where a prohibited image has been detected or in a case where a prohibited mark has been detected, the image of the region indicated by the detection region information out of the print image log 133b as the generated log information is to be erased (overwritten by high-density image). Therefore, even in a case where leakage of log information to the outside occurs, there would be no leakage of the images of the region indicated by the detection region information to the outside.

In a case where the image alteration program 123 has separated the image represented by the image data output from the edit processing program 122 into the region formed of a graphic image representing a figure and the region formed of a text image representing a text, and when a prohibited image or prohibited mark is has been detected, the region formed of the graphic image representing a figure may be regarded as a region where duplication is prohibited, and the region formed of the graphic image may be erased (overwritten by a high-density image) That is, it is possible to limit inclusion of a graphic image, which is a partial image, in the log information.

Furthermore, the image alteration unit 123A (log generation unit) may generate log information including an entire image, a partial image, or an altered image obtained by altering these images out of images represented by image data. Here, in a case where the reference image is detected, the image alteration unit 123A (log generation unit) may delete an entire image, a partial image, or an altered image in the log information generated by the image alteration unit 123A, or may alternatively overwrite a high-density image in which a plurality of pixels of a single color are densely arranged over the entire image, the partial image, or the altered image.

### 3 Second Modification

A second modification of the first embodiment will be described focusing on the differences from the first modification.

In the first modification, in a case where a prohibited image or a prohibited mark has been detected, the high-density image is overwritten over the region indicated by the detection region information included in the print image log as log information. However, the present invention is not limited to this.

In the second modification, in a case where a prohibited image or a prohibited mark has been detected, the image alteration unit 123A (storage restriction unit) overwrites a high-density image over an image of the region indicated by the detection region information in the generated log information. This makes it impossible for a person to recognize an image originally present in the region indicated by the detection region information.

Furthermore, the image alteration unit 123A uses a text image to draw the display information indicating that a prohibited image or a prohibited mark has been detected and inclusion of the prohibited image or the like in the log information is to be restricted in the region over which overwriting with the high-density image has been performed.

Note that the present invention is not limited to drawing the display information indicating that a prohibited image or a prohibited mark has been detected in the region overwriting has been performed with the high-density image. Display information may be added to the log information. For example, the display information may be drawn on a print image log as log information at a position other than the region where overwriting has been performed with the high-density image In addition, display information may be added to the log information, as text data.

(Print Image Data 131, Printed Product 132c and Print Image Log 133c)

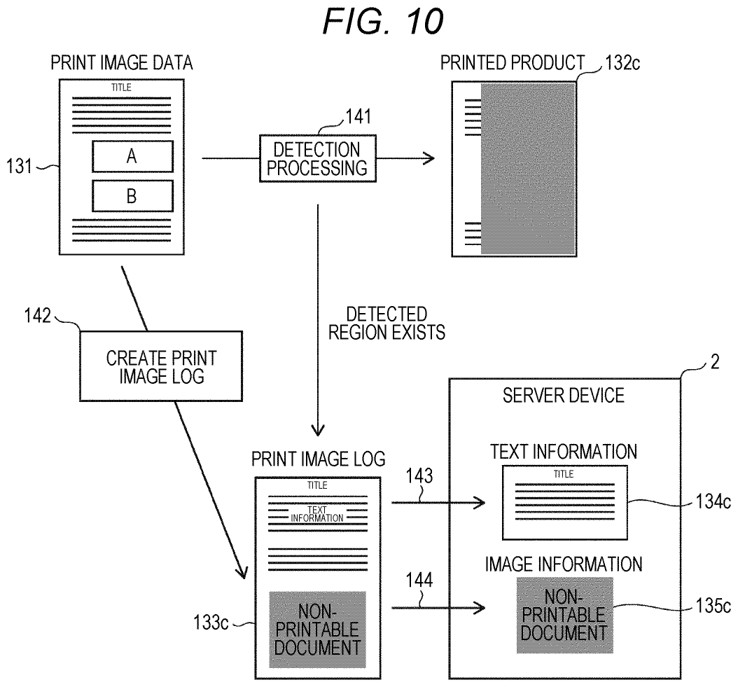

As an example, execution of a copy job and generation of log information in the second modification will be described using print image data 131, a printed product 132c, and a print image log 133c illustrated in FIG. 10. Here, the description will focus on differences from FIG. 8.

In a case where a prohibited image or a prohibited mark has been detected by the detection processing unit 124A, the edit processing unit 122A overwrites a high-density image over the region indicated by the detection region information of the print image data 131. As a result, the printed product 132c is output by the printer device 14.

Meanwhile, the image alteration unit 123A generates the print image log 133c in which an image is reduced, as log information. Here, in a case where a prohibited image or a prohibited mark is detected by the detection processing unit 124A, the image alteration unit 123A overwrites a high-density image over the region indicated by the detection region information in the print image log 133c as log information.

Furthermore, the image alteration unit 123A uses a text image to draw the display information indicating that a prohibited image or a prohibited mark has been detected, over the region where overwriting with the high-density image has been performed. Here, information of “non-printable document” is drawn.

The print image log 133c is separated into a text data portion and an image data portion by the image alteration unit 123A. Text information 134c is transmitted to the server device 2 as log information (143), and image information 135c is transmitted to the server device 2 (144). Here, in the image information 135c, display information indicating that a prohibited image or a prohibited mark has been detected is overwritten over the high-density image (here, the solid image) in the image information 135c, and the image information 135c includes the display information alone.

(Operation in Image Log Management System 6 of Second Modification)

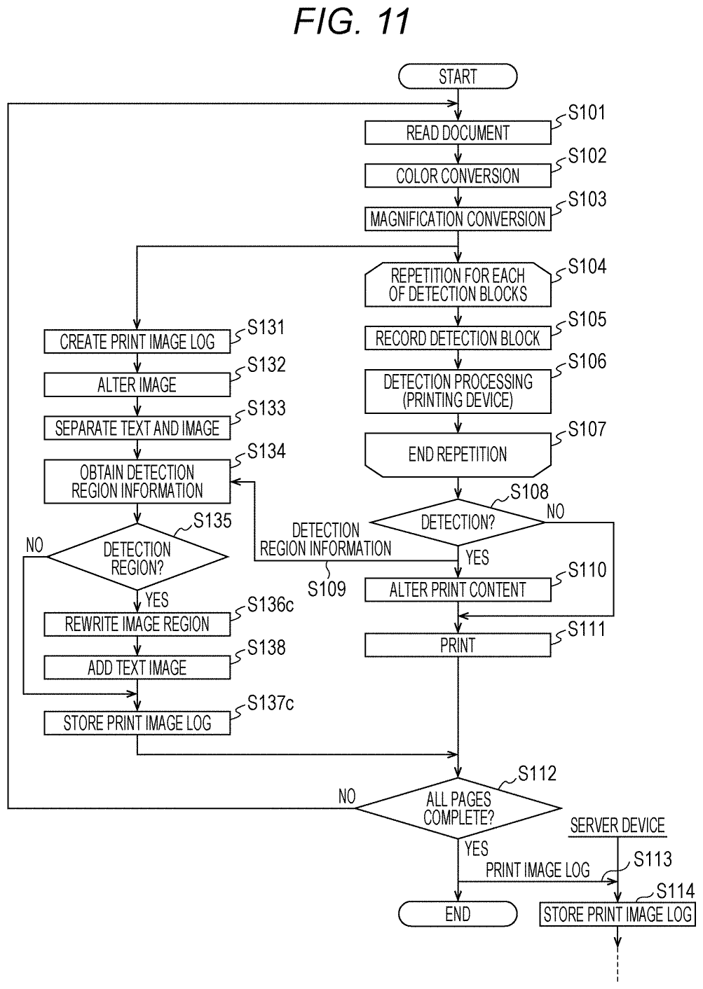

Operation of the image log management system 6 according to a second modification will be described with reference to the flowchart illustrated in FIG. 11. Here, the description will focus on differences from the operation of the first modification illustrated in FIG. 9.

In the second modification, the detection region information is obtained (steps S109 and S134). In a case where the detection region exists (“Yes” in step S135), the image alteration unit 123A performs rewriting by overwriting a high-density image over the region indicated by the detection region information out of the print image log (step S136c).

Furthermore, the image alteration unit 123A uses a text image to draw the display information indicating that a prohibited image or a prohibited mark has been detected over the region where overwriting with the high-density image has been performed, and thereby adds text image (step S138).

(Summary)

In this manner, in a case where a prohibited image has been detected or in a case where a prohibited mark has been detected, display information indicating that the prohibited image or the prohibited mark has been detected is drawn using a text image in the region indicated by the detection region information and over which a high-density image has been overwritten, out of the print image log 133c (FIG. 10) as the generated log information. Therefore, the user who has viewed the print image log 133c can learn the reason for overwriting with the high-density image

### 4 Third Modification

A third modification of the first embodiment will be described with a focus on differences from the first embodiment.

In the first embodiment, the print image log as log information is generated by reducing an image representing image data that is print image data at a first reduction rate. Here, in a case where a prohibited image or a prohibited mark is detected, the print image log as log information is discarded. However, the present invention is not limited to this.

In the third modification, in a case where a prohibited image or a prohibited mark has been detected, and when the first reduction rate at generation of the log information is a predetermined second reduction rate (threshold, prescribed value) or more, the image alteration unit 123A (storage restriction unit) further reduces an image of a region corresponding to the region indicated by the detection region information in the print image log as log information. This makes it impossible for a person to recognize an image corresponding to a prohibited image or the like in the print image log as log information.

(Print Image Data 131, Printed Product 132d, and Print Image Logs 133d and 136d)

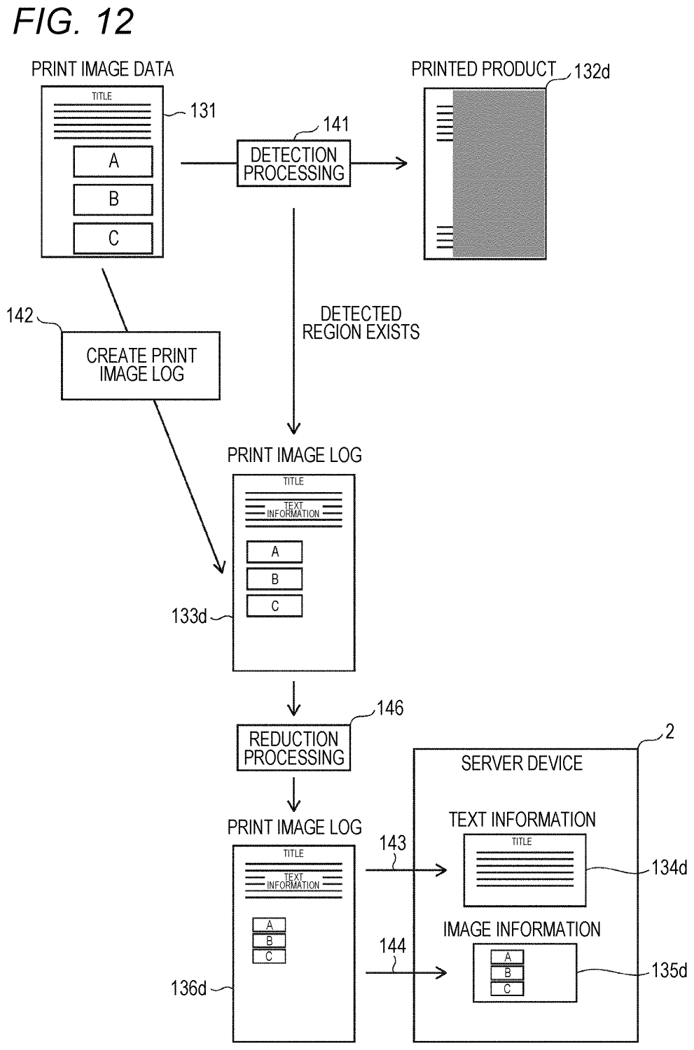

As an example, execution of a copy job and generation of log information in the third modification will be described using print image data 131, a printed product 132d, and a print image logs 133d and 136d, illustrated in FIG. 12. Here, the description will focus on differences from FIG. 6.

In a case where a prohibited image or a prohibited mark has been detected by the detection processing unit 124A, the edit processing unit 122A overwrites an image of the region indicated by the detection region information of the print image data 131 with a high-density image. As a result, the printed product 132d is output by the printer device 14.

Meanwhile, the image alteration unit 123A generates a print image log 133d obtained by reducing an image as log information at the first reduction rate. Here, in a case where a prohibited image or a prohibited mark is detected by the detection processing unit 124A, the first reduction rate and the second reduction rate are compared with each other. In a case where the first reduction rate is the second reduction rate or less, the print image log 133d would not be altered. In a case where the first reduction rate is larger than the second reduction rate, the image in the region corresponding to the region indicated by the detection region information in the print image log 133d is further reduced (146). As a result, the image in the region corresponding to the region indicated by the detection region information in the print image log 133d is reduced to the second reduction rate or less. In this manner, the print image log 136d is generated.

The print image log 136d is separated into a text data portion and an image data portion by the image alteration unit 123A. Text information 134d is transmitted to the server device 2 as log information (143), and image information 135d is transmitted to the server device 2 (144). Here, the reduced image included in the image information 135d is an image obtained by further reducing the reduction image included in the print image log 133d so that the reduction rate is the second reduction rate or less when viewed from the image of the region indicated by the detection region information of the original print image data 131.

(Operation in Image Log Management System 6 of Third Modification)

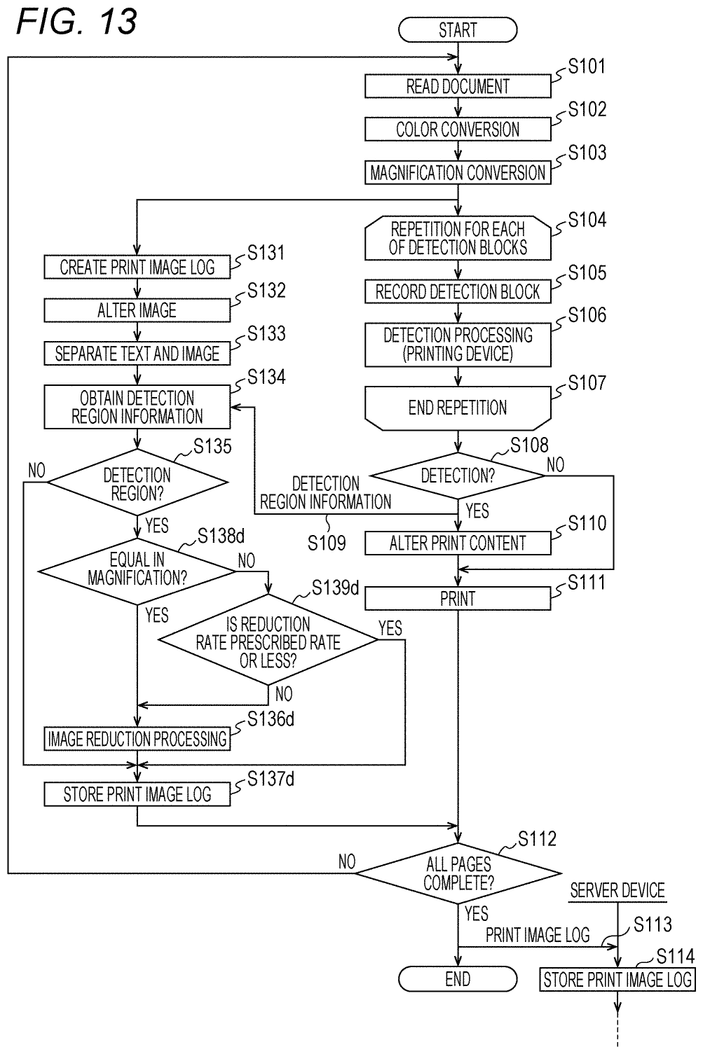

Operation of the image log management system 6 according to the third modification will be described with reference to the flowchart illustrated in FIG. 13. Here, the description will focus on the differences from the operation of the image log management system 6 of the first embodiment illustrated in FIG. 7.

In the third modification, detection region information is obtained (steps S109 and S134), and in a case where the detection region exists (“Yes” in step S135), the image alteration unit 123A determines, in the print image log as log information, whether the image corresponding to the prohibited image or the like is equal in magnification to the prohibited image or the like included in the original print image data (step S138d).

In a case where the images are not equal in magnification (NO in step S138d), the first reduction rate and the second reduction rate (prescribed value) are compared with each other (step S139d). In a case where the first reduction rate is the second reduction rate or less (YES in step S139d), alteration would not be performed on the print image log 133d.

In a case where the image corresponding to the prohibited image is equal in magnification to the prohibited image included in the original print image data (YES in step S138d ), or in a case where the first reduction rate is larger than the second reduction rate (in step S139d ) NO), the image alteration unit 123A further reduces the image corresponding to the prohibited image or the like of the print image log 133d (step S136d).

Next, the image log recording unit 125A writes the print image log in the data storage 23 (step S137b).

(Summary)

As described above, the image alteration unit 123A generates the print image log 133d obtained by reducing an image as log information at the first reduction rate. In a case where a prohibited image or a prohibited mark is detected, the first reduction rate and the second reduction rate (prescribed value) are compared with each other. In a case where the first reduction rate is the second reduction rate or less, the print image log 133d would not be altered. In a case where the first reduction rate is larger than the second reduction rate, the image corresponding to the prohibited image or the like of the print image log 133d is further reduced. As a result, even in a case where leakage of log information to the outside occurs, there would be no leakage of the image corresponding to the prohibited image to the outside to be used as a genuine product.

In a case where an image corresponding to a prohibited image or the like included in the log information is the same as the original prohibited image or the like, or indistinguishably similar to the original prohibited image or the like, there is a possibility that the image corresponding to the prohibited image or the like included in the log information might be used as a genuine image. In order to avoid this, the image corresponding to the prohibited image included in the log information is further reduced (second reduction). In this case, instead of the second reduction, the image corresponding to the prohibited image or the like included in the log information may be removed, or a high-density image may be overwritten over the image.

In contrast, there might be a situation where the image corresponding to the prohibition image included in the log information so different from the original prohibited image or the like that it can be easily distinguished by a person. In this situation and in a case where the image corresponding to a prohibited image or the like is already reduced to an extent that cannot be recognized as a duplication-prohibited image, there would be no need to further reduce the image corresponding to the prohibited image or the like, no need to remove the image corresponding to the prohibited image, and no need to overwrite a high-density image over the image corresponding to the prohibited image or the like.

Here, in a case where an image obtained by enlarging a prohibited image by 1.5 times, for example, is included in the image data generated by reading the document surface by the scanner device 13 or in the image data generated by the RIP program 121 from the print job received from an external terminal device via the communication network 3, it would be possible, as described in the third modification, that when the image data is reduced by, for example, 1/1.5 times, an image corresponding to the prohibited image might become the same size as the original prohibited image. In this case, leakage of the reduced image to the outside as log information might lead to the use of the image corresponding to the prohibited image or the like as a genuine image, and thus, such a situation must be avoided. Therefore, when a prohibited image or a prohibited mark is detected, log information is to be maintained with no change when the first reduction rate of the reduced image included in the log information with respect to the original-sized image corresponding to the image represented by the image data is the second reduction rate (prescribed value) or less. In contrast, when the first reduction rate exceeds the second reduction rate, the reduced image may be further reduced so that the first reduction rate becomes the second reduction rate or less in the log information.

Here, the RAM 21 illustrated in FIG. 3 may store, for example, a prohibited image or the like obtained by reducing an original-sized prohibited image or the like, by, for example, 0.5 times, 0.6 times, 0.7 times, 0.8 times, 0.9 times or enlarging the image by 1.1 times, 1.2 times, 1.3 times, 1.4 times, and 1.5 times, as the prohibited image or the like, in association with the magnification levels. When such a reduced or enlarged prohibited image or the like is detected in the image data, the original size of the prohibited image or the like can be obtained by the magnification corresponding to the detected prohibited image or the like.

### 5 Second Embodiment

An image log management system 6e (not illustrated) as another embodiment according to the present invention will be described with reference to the drawings with a focus on differences from the first embodiment.

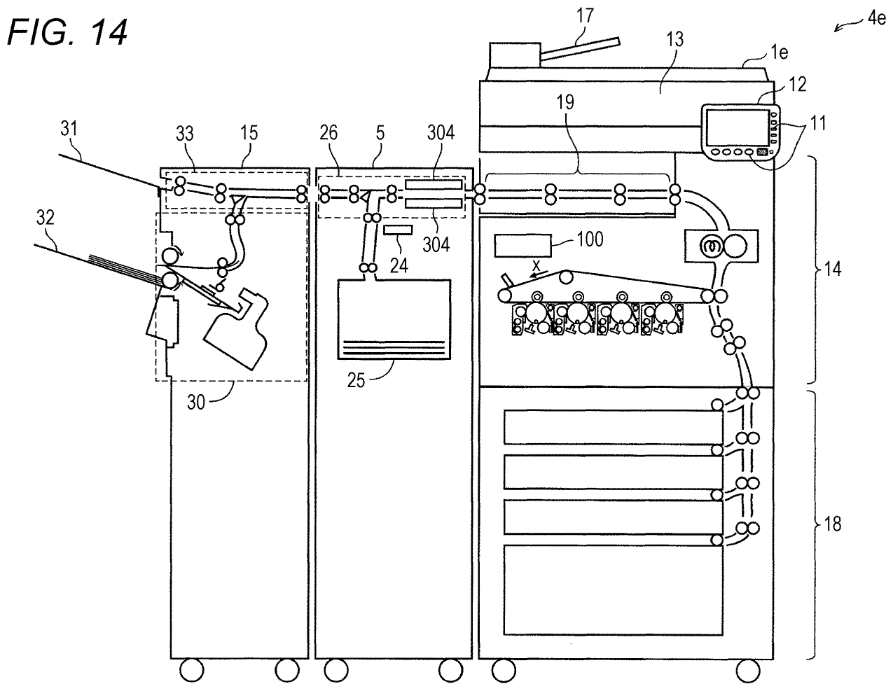

The image log management system 6e includes an image forming system 4e (FIG. 14) instead of the image forming system 4 of the first embodiment.

In other words, the image log management system 6e includes the image forming system 4e and the server device 2, and the image forming system 4e and the server device 2 are connected with each other via the communication network 3.

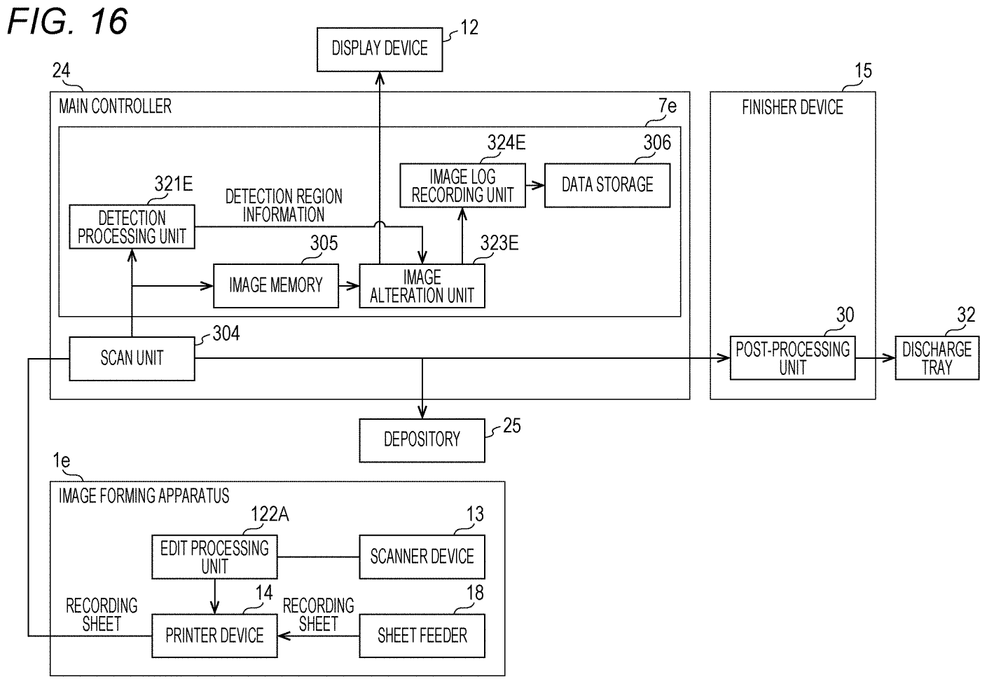

Similar to the image forming system 4, the image forming system 4e reads a document surface and executes a copy job that forms an image on a recording sheet by electrophotography. Furthermore, the image forming system 4e also includes an image log management apparatus 7e (FIG. 16) that generates and manages image logs as image data indicating the execution result of copy jobs. The image forming system 4e transmits the generated log information to the server device 2 via the communication network 3.

The server device 2 is the same as the server device 2 according to the first embodiment.

5.1 Image Forming System 4e

As illustrated in FIG. 14, the image forming system 4e includes: an image forming apparatus 1e (image processing apparatus) that forms an image on a recording sheet by electrophotography; a reading apparatus 5 (inspection apparatus) that detects a prohibited image or a prohibited mark, and is used for storing recording sheets on which an image including the prohibited image or the prohibited mark is formed; and a finisher device 15.

The finisher device 15 has the same configuration as the finisher device 15 of the first embodiment. Therefore, the description of the finisher device 15 is omitted.

(1) Image Forming Apparatus 1e

The image forming apparatus 1e has the same configuration as the image forming apparatus 1 of the first embodiment except for the following points.

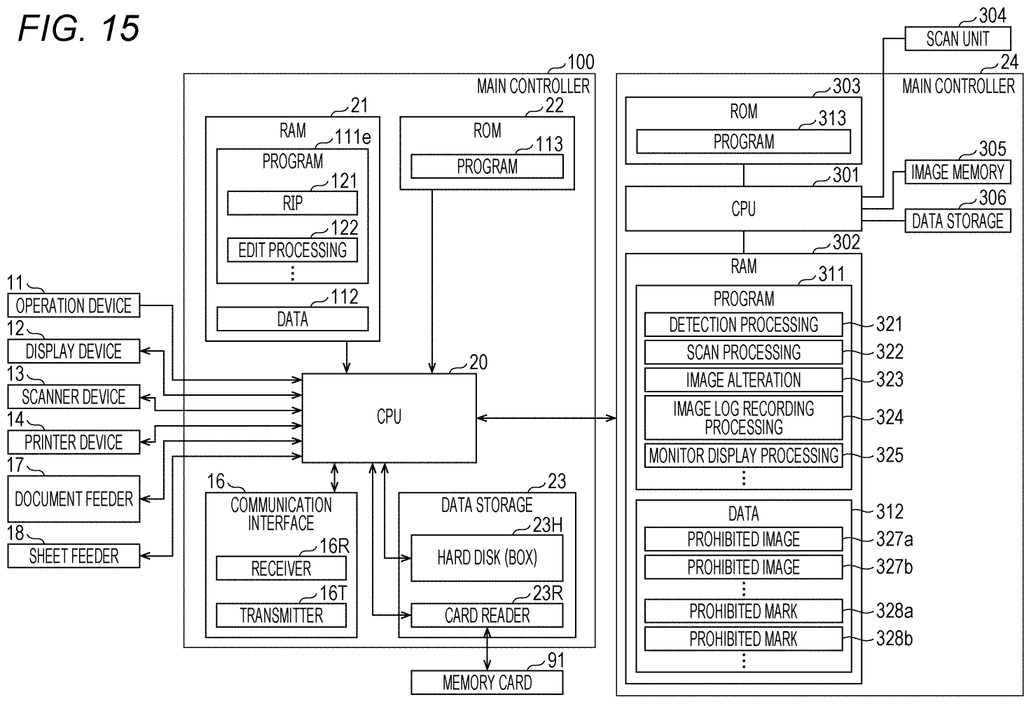

FIG. 15 illustrates the main controller 100 of the image forming apparatus 1e.

The RAM 21 of the main controller 100 stores a program 111e as illustrated in FIG. 15, instead of the program 111 of the first embodiment.

The program 111e includes a RIP program 121, an edit processing program 122, or the like.

The RIP program 121 and the edit processing program 122 are the same as the RIP program 121 and the edit processing program 122 of the first embodiment.

Here, operating the CPU 20 following the edit processing program 122 allows the edit processing unit 122A illustrated in FIG. 16 to operate. This is also similar to the first embodiment.

Furthermore, as illustrated in FIG. 14, the conveyance unit 19 has a conveyance path formed in the horizontal direction. The recording sheet on which an image has been formed is conveyed by a plurality of conveyance roller pairs arranged along the conveyance path to be output to the reading apparatus 5.

(2) Reading Apparatus 5

As illustrated in FIG. 14, the reading apparatus 5 includes: a depository 25 inside the housing; and a conveyance path 26 provided above the depository 25 so as to face the conveyance unit 19. In addition, a main controller 24 is provided inside the housing, providing the reading apparatus 5 with the image log management apparatus 7e (FIG. 16).

On the conveyance unit 19 side of the conveyance path 26, a scan unit 304 is provided so as to sandwich the conveyance path 26 from upper and lower directions. The scan unit 304 detects a prohibited image or a prohibited mark in an image on a recording sheet conveyed from the conveyance unit 19.

In a case where the scan unit 304 has not detected a prohibited image or a prohibited mark, the reading apparatus 5 allows the recording sheet to pass through the conveyance path 26 toward the conveyance path 33 of the finisher device 15 under the control of the main controller 24.

In contrast, in case where a prohibited image or a prohibited mark has been detected by the scan unit 304, the recording sheet output from the conveyance unit 19 is branched in the middle of the conveyance path 26 to the depository 25 under the control of the main controller 24. The depository 25 stores a recording sheet that carries a prohibited image or a prohibited mark detected. The depository 25 is locked so that a recording sheet stored in the depository 25 cannot be retrieved by a general user.

(3) Main Controller 24 and Scan Unit 304

As illustrated in FIG. 15, the main controller 24 includes a CPU 301, a RAM 302, a ROM 303, image memory 305, and data storage 306.

The ROM 303 stores a program 313. The program 313 is a control computer program for integrally controlling the main controller 24.

The RAM 302 stores a program 311 and data 312. The data 312 includes various control variables, prohibited images 327a, 327b, . . . and prohibited marks 328a, 328b, . . . used in the scan unit 304 or the like. The RAM 302 provides a work area to be used in execution of programs by the CPU 301.

The CPU 301 operates in accordance with the program 313 stored in the ROM 303 and thereby controls the image memory 305, the data storage 306, or the like.

The data storage 306 is formed by a hard disk, for example. The data storage 306 is used to store log information or the like described below.

As illustrated in FIG. 15, the program 311 stored in the RAM 302 includes a detection processing program 321, a scan processing program 322, an image alteration program 323, an image log recording program 324, a monitor display processing program 325, or the like.

Here, the CPU 301 operates in accordance with the detection processing program 321, the image alteration program 323, and the image log recording program 324, so as to enable operation of a detection processing unit 321E (detection unit), an image alteration unit 323E (storage restriction unit) and an image log recording unit 324E, respectively, as illustrated in FIG. 16.

The scan unit 304 operates in accordance with the scan processing program 322, reads an image on the front surface (or front surface and back surface) of the recording sheet output from the conveyance unit 19, generates image data, and outputs the generated image data to the detection processing unit 321E, and then, writes the generated image data into the image memory 305.

The prohibited images 327a, 327b, . . . are the same as the prohibited images 127a, 127b, . . . according to the first embodiment. Further, the prohibited marks 328a, 328b, . . . are the same as the prohibited marks 128a, 128b, . . . according to the first embodiment.

The detection processing program 321 is the same as the detection processing program 124 of the first embodiment.

The scan processing program 322 controls the scan unit 304 to read an image formed on the front surface (or the front surface and the back surface) of the recording sheet passing through the conveyance path 26 to generate image data, write the generated image data in the image memory 305, and output the generated image data to the detection processing unit 321E.

The image alteration program 323 is the same as the image alteration program 123 of the first embodiment.

The image log recording program 324 is the same as the image log recording program 125 of the first embodiment.

5.2 Copy Job Execution and Log Information Generation in Image Forming System 4e

As an example, execution of a copy job and generation of log information in the image forming system 4 will be described with reference to the block diagram illustrated in FIG. 16.

The sheet feeder 18 feeds a recording sheet to the printer device 14.

The scanner device 13 reads an image from a document to generate image data. The edit processing unit 122A performs editing such as color conversion on the generated image data, and outputs the edited image data to the printer device 14.

The printer device 14 forms an image on a recording sheet. Next, the recording sheet is output toward the scan unit 304.

The scan unit 304 reads an image formed on the front surface (or front surface and back surface) of the recording sheet, generates image data, writes the generated image data in the image memory 305, and outputs the generated image data to the detection processing unit 321E.

The detection processing unit 321E acquires image data, and detects a prohibited image or a prohibited mark as a reference image from the image data.

The image alteration unit 323E reads image data from the image memory 305, performs image reduction processing on the read image data, and generates image data obtained by reducing the image, as log information. In a case where a prohibited image has been detected or a prohibited mark has been detected, the image alteration unit 323E discards the generated log information. In this manner, the generated log information is discarded in a case where a prohibited image is detected or in a case where a prohibited mark is detected, and thus, there would be no leakage of log information to the outside.

In a case where the prohibited image has not been detected and in a case where the prohibited mark has not been detected, the image alteration unit 323E outputs the log information with no change to the image log recording unit 324E.

The image log recording unit 324E writes the received log information in the data storage 306.

The transmitter 16T of the communication interface 16 periodically transmits the log information written in the data storage 306 to the server device 2 via the communication network 3.

In a case where the prohibited image has not detected, and in a case where the prohibited mark has not been detected, the recording sheet that has passed through the main controller 24 is conveyed to the finisher device 15 and is stapled in the post-processing unit 30 and then, output to the discharge tray 32.

In a case where the prohibited image is detected or in a case where the prohibited mark is detected, the recording sheet that has passed through the main controller 24 is to be stored in the depository 25.

Here, the image memory 305, the image alteration unit 323E, the detection processing unit 321E, the image log recording unit 324E, and the data storage 306 illustrated in FIG. 16 form the image log management apparatus 7e.

5.3 Operation in Image Log Management System 6e

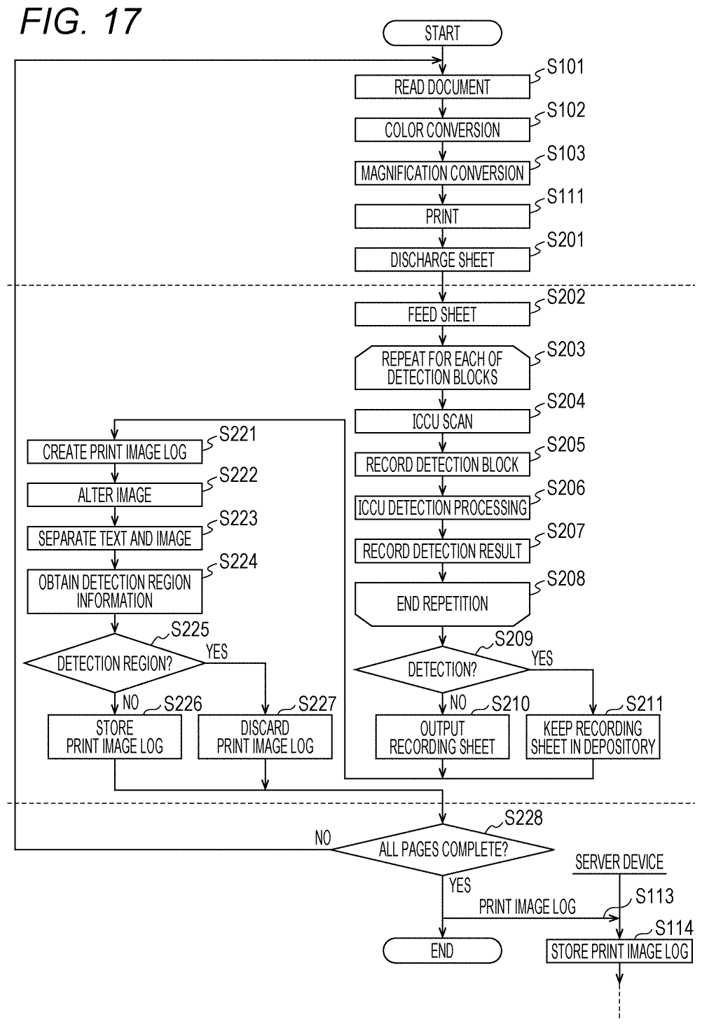

Operation in the image log management system 6e will be described with reference to the flowchart illustrated in FIG. 17.

The scanner device 13 reads an image from a document to generate image data (step S101). The edit processing unit 122A performs color conversion (step S102), and further performs magnification conversion (step S103).

An image is formed on a recording sheet by the printer device 14 (step S111), and the recording sheet is output (step S201).

Here, steps S101 to S201 include operation in the image forming apparatus 1e.

Next, the recording sheet on which the image is formed is fed to the reading apparatus 5 (step S202).

Next, for each of a plurality of detection blocks forming the image on the recording sheet, execution of reading of an image (detection block) by the scan unit 304 (step S204), recording of the detection block in the buffer (RAM 302) (step S205), detection processing for the recorded detection block (step S206), and recording of the detection result (step S207) will be repeated for each of the detection blocks (steps S203 to S208).

Next, in a case where the prohibited image or the prohibited mark is detected by the detection processing unit 321E (“Yes” in step S209), the recording sheet is stored in the depository 25 (step S211). In contrast, in a case where no prohibited image or prohibited mark is detected by the detection processing unit 321E (“None” in step S209), the recording sheet is output to the finisher device 15 (step S210).

Here, steps S202 to S211 are operation in the reading apparatus 5.

Next, the image alteration unit 323E reduces the image data and generates a print image log as log information (step S221). The image alteration unit 323E add, to the print image log, job ID for identification of copy jobs, job type, job reception time (year/month/day, hour/minute/second), job end time (year/month/day, hour/minute/second), a job status, or the like (step S222). Next, the image alteration unit 323E separates the text data portion and the image data portion from the print image log (step S223).

Next, the image alteration unit 323E obtains detection region information (step S224). In a case where the detection region does not exist (“No” in step S225), the image log recording unit 324E writes the print image log in the data storage 306 (step S226).

In contrast, in a case where the detection region exists (“Yes” in step S225), the image alteration unit 323E discards the print image log. The print image log will not be written in the data storage 23 (step S227).

Here, steps S221 to S227 are operation in the reading apparatus 5.

Next, after completion of printing of all pages for the copy job (YES in step S228), a print image log as log information is transmitted to the server device 2 by the transmitter 16T. The communication unit 202 of the server device 2 receives the print image log (step S113). The storage 203 stores the received print image log (step S114). This completes the processing for the print image log as log information.

In a case where printing of all pages is not completed for the copy job (NO in step S228), control is then shifted to step S101, and the processing is repeated.

Here, steps S228 and S113 are operation in the image forming apparatus 1e, and steps S113 and S114 are operation in the server device 2.

5.4 Summary

As described above, in a case where a prohibited image or a prohibited mark is detected in the scanned image data by the main controller 24, the print image log as log information will be discarded. That is, in a case where a prohibited image or a prohibited mark is detected in the image data, there is a restriction on inclusion of the entire image out of the images represented by the image data in the log information with no change. Therefore, there would be no leakage of the print image log as log information to the outside. In this manner, it is possible to prevent leakage of a prohibited image or the like, which is duplication prohibited, to the outside.

5.5 Modifications

(1) As described above, in a case where a prohibited image or a prohibited mark is detected in the scanned image data by the main controller 24, the print image log as log information will be discarded.

However, the present invention is not limited to this.

In a case where a prohibited image or a prohibited mark is detected in the scanned image data by the main controller 24, the high-density image may be overwritten over the region indicated by the detection region information in the print image log as log information. It is also allowable to draw a text image indicating prohibition in the region over which the high-density image is overwritten. Alternatively, the region indicated by the detection region information in the print image log may be reduced at a prescribed reduction rate or less.

In this manner in a case where a prohibited image or a prohibited mark is detected in the image data, there is a restriction on inclusion of the entire image or the partial image out of the images represented by the image data in the log information with no change.

In a case where a prohibited image or prohibited mark is detected, a high-density image is overwritten over the prohibited image or the like in the print image log as log information, or the prohibited image or the like is reduced at a prescribed reduction rate or below. Accordingly, even in a case where the print image log as information is leaked to the outside, it is possible to prevent the leakage of the prohibited image or the like that is duplication prohibited to the outside to be used as a genuine product.

(2) As described above, in a case where a prohibited image or a prohibited mark is detected, the recording sheet is stored in the depository 25.

However, the present invention is not limited to this.

The reading apparatus 5 illustrated in FIG. 14 may include a cutting machine and a storage part instead of the depository 25. In a case where a prohibited image or a prohibited mark is detected, the recording sheet may be conveyed to a cutting machine, cut into strips by the cutting machine, and then stored in the storage part.

6 Other modifications

(1) In the first embodiment, the second embodiment, and the modifications described above, log information is generated and a prohibited image or a prohibited mark is detected. In a case where a prohibited image or prohibited mark is detected, the image corresponding to the prohibited image or the like is removed from the generated log information, overwriting is performed onto the image corresponding to the prohibited image or the like of the log information, and the generated log information is discarded.

However, the present invention is not limited to these.

In a case where a prohibited image or prohibited mark has been detected, the image alteration unit (log generation unit) may generate log information from which the image corresponding to the prohibited image or the like has been removed, and overwriting may be performed over the image corresponding to the prohibited image or the like and log information may be generated, or generation of log information may be restricted.

Specifically, in a case where a prohibited image or a prohibited mark is detected, the image alteration unit may generate log information including a remaining image left after removing a partial image or an altered image obtained by altering this image, out of the images represented by the image data, or may alternatively generate log information including the entire image, the partial image, or an image obtained by overwriting a high-density image including a plurality of single color pixels densely arranged over an altered image obtained by altering these images, out of the images represented by the image data.

In addition, the image alteration unit may restrict generation of log information in a case where a prohibited image or a prohibited mark is detected. In a case where a prohibited image and a prohibited mark are not detected, the image alteration unit may generate log information including an entire image, a partial image, or an altered image obtained by altering these images, out of the images represented by the image data.

(2) An image log management system as another modification may include a scanner device (image processing apparatus, image reading apparatus) instead of the image forming system 4 of the first embodiment.

The scanner device is connected to a PC.

The scanner device executes, as an image processing job, a scan job (image reading job) that reads a document image, generates image data, and outputs a generated image data to the PC. The scanner device also includes an image log management apparatus that manages image data indicating the execution result of the scan job, as an image log.

The scanner device includes a detection processing unit, an image alteration unit, an image log recording unit, and a data storage illustrated in FIG. 4.

The detection processing unit acquires image data generated by reading an image of a document, and detects a prohibited image or a prohibited mark on the acquired image data.

The image alteration unit reduces an image of the image data generated by reading an image of a document, and generates a print image log as log information. In a case where a prohibited image or a prohibited mark is detected by the detection processing unit, the image alteration unit discards the generated print image log. Alternatively, the image alteration unit may overwrite a high-density image over the image corresponding to the prohibited image or the like in the generated print image log. Alternatively, the image alteration unit may overwrite a high-density image over the image corresponding to a prohibited image or the like in the generated print image log, and a text image indicating that a prohibited image or a prohibited mark has been detected may be drawn in the region over which the high-density image is overwritten. The image alteration unit may also reduce an image corresponding to a prohibited image or the like at a prescribed reduction rate or less, in the generated print image log.

The image log recording unit writes the print image log generated as described above into the data storage.

The scanner device may include a communication interface that connects to a communication network. The communication interface may transmit the print image log stored in the data storage to the server device 2 via the communication network. The server device 2 receives a print image log and stores the received print image log.

The print image log stored in the server device 2 is used, for example, to analyze the execution result of the scan job executed on the scanner device.

In this manner in a case where a prohibited image or a prohibited mark is detected in the image data, there is a restriction on inclusion of the entire image or the partial image out of the images represented by the image data in the log information with no change.

According to the above configuration, an image corresponding to a prohibited image or the like is not included in the log information, making it possible to achieve an excellent effect of preventing unauthorized use of the prohibited image or the like included in the log information.

(3) In the image forming apparatus 1 according to the first embodiment, the program 111 stored in the RAM 21 need not include the detection processing program 124. That is, the image forming apparatus 1 need not include the detection processing unit 124A illustrated in FIG. 4.

Accordingly, the image forming apparatus stores the print image log as log information generated from the image data in the data storage 23 even in a case where the image data includes a prohibited image or a prohibited mark, and the print image log stored in the data storage 23 is transmitted to the server device 2, and the storage 203 of the server device 2 stores the print image log.

Here, the server device 2 may include a detection processing unit and an image alteration unit illustrated in FIG. 4. The detection processing unit provided in the server device 2 reads a print image log from the storage 203 and thereby acquires the print image log, and detects a prohibited image or a prohibited mark from the image of the acquired print image log. In a case where a prohibited image or a prohibited mark is detected, the image alteration unit discards the generated print image log. Alternatively, the image alteration unit may overwrite a high-density image over the image corresponding to the prohibited image or the like in the generated print image log. Alternatively, the image alteration unit may overwrite a high-density image over the image corresponding to a prohibited image or the like in the generated print image log, and a text image indicating that a prohibited image or a prohibited mark has been detected may be drawn in the region over which the high-density image is overwritten. The image alteration unit may also reduce an image corresponding to a prohibited image or the like at a prescribed reduction rate or less, in the generated print image log.

As described above, even in a case where the server device 2 has received the print image log including a prohibited image or a prohibited mark, the image corresponding to the prohibited image or the like will not be included in the print image log. Accordingly, even in a case where the log information leaks from the server device 2, it is possible to achieve an excellent effect of being able to prevent an unauthorized use of a prohibited image or the like included in log information.

(4) In the image forming apparatus 1 of the first embodiment, the image log management apparatus may manage the log information that indicates the execution result of the print job (image forming job) of forming an image based on the image data received from an external terminal device of the image forming apparatus 1.

The receiver 16R receives image data from an external terminal device and thereby acquires the image data.

The detection processing unit 124A detects a prohibited image or a prohibited mark from the acquired image data.

In a case where a prohibited image or a prohibited mark is detected, the image alteration unit 123A restricts inclusion of the entire image or the partial image with no change out of the images represented by the image data in the log information (print image log) generated as a result of the execution of the image forming job. That is, the image alteration unit 123A may discard the generated print image log. Alternatively, the image alteration unit 123A may overwrite a high-density image over an image corresponding to the prohibited image or the like in the generated print image log. Alternatively, the image alteration unit 123A may overwrite a high-density image over an image corresponding to the prohibited image or the like in the generated print image log, and may draw a text image indicating that a prohibited image is detected in the region over which a high-density image is overwritten. Alternatively, the image alteration unit 123A may also reduce an image corresponding to a prohibited image or the like at a prescribed reduction rate or less, in the generated print image log.

In this manner, even in a case where a prohibited image or a prohibited mark is included in the image data received from an external terminal device, inclusion of the image corresponding to the prohibited image or the like in the log information would be suppressed. Accordingly, it is possible to prevent an unauthorized use of a prohibited image or the like included in the log information.

(5) In each of the above-described embodiments and modifications, the image forming apparatus forms an image on a recording sheet by electrophotography. However, the present invention is not limited to this.

The image forming apparatus may form an image on a recording sheet by an inkjet method.

(6) Each of the above embodiments has been described as an exemplary case where the print job is received via the communication interface 16 via a communication network such as a LAN. However, other communication means such as Bluetooth (registered trademark) may be used for reception.

(7) Each of the devices described above is a computer system including a microprocessor and memory. The memory may store a computer program for control, and the microprocessor may operate in accordance with the computer program.

Here, the computer program includes a plurality of combined instruction codes indicating commands to the computer in order to achieve a predetermined function.

The computer program may be recorded on a computer readable recording medium, such as a flexible disk, a hard disk, an optical disk, semiconductor memory, or the like.

The computer program may be transmitted via a wired or wireless telecommunication line, a communication network represented by the Internet, data broadcasting, or the like.

(8) The above embodiments and the above modifications may be combined with each other.

The image log management apparatus according to the present invention restricts the inclusion of an image corresponding to a prohibited image or the like in the image log. This makes it possible to achieve an effect of preventing an unauthorized use of a prohibited image or the like included in the image log. For this reason, the apparatus is useful as a technology for the management of the records of job execution result in a case where an image processing apparatus executes a job such as copying, scanning, or printing.

Although embodiments of the present invention have been described and illustrated in detail, the disclosed embodiments are made for purposes of illustration and example only and not limitation The scope of the present invention should be interpreted by terms of the appended claims

What is claimed is:

1. An image log management apparatus that manages image data indicating an execution result of an image processing job on an image processing apparatus, as an image log, the apparatus comprising:
a hardware processor that:
performs detection of whether a predetermined reference image is included in the image data related to the image processing job; and
restricts storage of an entire image or a partial image as an image log, out of images represented by the image data, in a case where the reference image is detected.

2. The image log management apparatus according to claim 1,
wherein the hardware processor generates the image log including an entire image, a partial image or an altered image obtained by altering these images, out of the images represented by the image data, and
in a case where the reference image is detected, the hardware processor deletes the entire image, the partial image, or the altered image in the image log generated by the hardware processor, or overwrites a high-density image including a plurality of densely arranged pixels of a single color over the entire image, the partial image, or the altered image.

3. The image log management apparatus according to claim 1
wherein the hardware processor generates the image log including an entire image, a partial image or an altered image obtained by altering these images, out of images represented by the image data, and
the hardware processor discards the generated image log in a case where the reference image is detected.

4. The image log management apparatus according to claim 1,
wherein in a case where the reference image is detected, the hardware processor generates of the image log including a remaining image after removing a partial image or an altered image obtained by altering this image out of images represented by the image data, or generates the image log including an image obtained by overwriting a high-density image including a plurality of highly densely arranged pixels of a single color over an entire image, a partial image, or an altered image obtained by altering these images, out of the images represented by the image data.

5. The image log management apparatus according to claim 1,
wherein the hardware processor restricts the generation of the image log in a case where the reference image is detected, and generates the image log including an entire image, a partial image, or an altered image obtained by altering these images, out of the images represented by the image data in a case where the reference image is not detected.

6. The image log management apparatus according to claim 2,
wherein the high-density image is a solid image including a plurality of pixels of a single color alone.

7. The image log management apparatus according to claim 2,
wherein, in a case the high-density image is to undergo further overwriting, the hardware processor adds display information indicating that the restriction has been applied, to the image log.

8. The image log management apparatus according to claim 7,
wherein the hardware processor further draws the display information using a text image on the image over which the high-density image has been overwritten.

9. The image log management apparatus according to claim 1,
wherein the hardware processor generates the image log including an image obtained by reducing an entire image or a partial image, out of images represented by the image data, and
in a case where the reference image is detected, the hardware processor maintains the image log with no change when a reduction rate of the reduced image included in the image log with respect to an original-sized image corresponding to the image represented by the image data is a threshold or less, and further reduces the reduced image so that the reduction rate becomes the threshold or less in the image log when the reduction rate exceeds the threshold.

10. The image log management apparatus according to claim 1,
wherein the hardware processor, in a case where the reference image is detected, generates the image log including a reduced image obtained by reducing an entire image or a partial image at a reduction rate being a threshold or less, out of the images represented by the image data.

11. The image log management apparatus according to claim 1,
wherein the hardware processor alters an image by separating a text image representing a text and a graphic image representing a figure from the image represented by the image data, and
in a case where the reference image is detected, the hardware processor restricts inclusion of the extracted graphic image or an altered image obtained by altering the graphic image, out of the images represented by the image data, in the image log.

12. The image log management apparatus according to claim 1,
wherein the reference image is a prohibited image that is at least a part of an image displayed on a surface of a duplication prohibited voucher or a prohibited mark that is put on a surface of a printed product and that indicates prohibition of duplication of the printed product.

13. The image log management apparatus according to claim 1,
wherein the reference image includes a feature pattern that includes a predetermined feature.

14. The image log management apparatus according to claim 1,
wherein the image processing apparatus is implemented as an image reading apparatus that reads an image on a document surface, and
the image data is generated by reading an image on the document surface using the image reading apparatus.

15. The image log management apparatus according to claim 1,
wherein the image processing apparatus is implemented as an image forming apparatus that forms an image on a sheet and reads the image formed on the sheet, and
the image data is generated by reading the image formed on the sheet.

16. The image log management apparatus according to claim 1,
wherein the image processing apparatus is implemented as an image forming apparatus that forms an image on the basis of image data, and
the image data is received from an external device connected to the image forming apparatus.

17. An inspection apparatus that inspects whether a predetermined reference image is included in image data, the apparatus comprising
the image log management apparatus according to claim 1.

18. An image forming apparatus that performs image formation, the apparatus comprising
the image log management apparatus according to claim 1.

19. An image reading apparatus that reads a document surface and generates image data, the apparatus comprising
the image log management apparatus according to claim 1.

20. An image forming system comprising:
an image forming apparatus that performs image formation; and
an inspection apparatus that inspects whether a predetermined reference image is included in image data,
wherein the inspection apparatus includes
the image log management apparatus according to claim 1.

21. A control method used in an image log management apparatus that manages image data indicating an execution result of an image processing job on an image processing apparatus, as an image log, the method comprising:
detecting whether a predetermined reference image is included in the image data related to the image processing job; and
restricting storage of an entire image or a partial image as an image log, out of images represented by the image data, in a case where the reference image is detected.

22. A non-transitory recording medium storing a computer readable program for control that is used on an image log management apparatus that manages image data indicating an execution result of an image processing job on an image processing apparatus, as an image log,
the computer program designed to cause the image log management apparatus being a computer to execute:
detecting whether a predetermined reference image is included in the image data related to the image processing job; and
restricting storage of an entire image or a partial image as an image log, out of images represented by the image data, in a case where the reference image is detected.
